(19) United States
(12) Patent Application Publication
(10) Pub. No.: US 2025/0083070 A1
(43) Pub. Date: Mar. 13, 2025

(54) TWO-MEMBRANE ELUENT GENERATOR AND CHROMATOGRAPHY DETECTION APPARATUS

(71) Applicant: SHIMADZU(CHINA)CO., LTD., Shanghai (CN)

(72) Inventors: Bo XU, Shanghai (CN); Yue ZHOU, Shanghai (CN)

(21) Appl. No.: 18/827,147

(22) Filed: Sep. 6, 2024

(30) Foreign Application Priority Data
Sep. 12, 2023 (CN) 202311176003.6

(51) Int. Cl. B01D 15/10; B01D 15/42

(52) U.S. Cl. CPC B01D 15/10; B01D 15/424

(57) ABSTRACT

Provided is a two-membrane eluent generator and a chromatography detection apparatus. The two-membrane eluent generator includes a stock solution channel; an eluent channel, a first ion-exchange membrane set being arranged between the eluent channel and the stock solution channel, the first ion-exchange membrane set including at least one ion-exchange membrane; a regenerant solution channel, a second ion-exchange membrane set being arranged between the eluent channel and the regenerant solution channel, the second ion-exchange membrane set including one bipolar membrane, wherein hydrogen ions or hydroxide ions generated at the bipolar membrane from electrolysis of a regenerant solution respectively enter different sides of the bipolar membrane, and impurity ions are prevented from entering the eluent channel through the bipolar membrane. The chromatography detection apparatus provided in present disclosure includes the two-membrane eluent generator. The present disclosure applies a bipolar membrane between the regeneration channel and the eluent channel, and is thus capable of supplying corresponding hydrogen ions or hydroxide ions for the eluent channel while preventing impurity ions in the regenerant solution from entering the eluent channel, thereby increasing the purity of the eluent.

### TECHNICAL FIELD

The present disclosure relates to the field of analytical instrumentation, in particular to a two-membrane eluent generator and a chromatography detection apparatus.

### BACKGROUND

With reference to FIGS. 1 and 2, in a two-membrane eluent generator learned by the inventor of the present disclosure, e.g., using a KOH-type eluent, the eluent generator 5 is partitioned by the cation-exchange membrane 61 and the anion-exchange membrane 62 into the eluent channel 63, and the stock solution channel 64 and the regenerant solution channel 65 on both sides of the eluent channel 63.

KOH as the stock solution is in direct communication with the stock solution channel 64. The eluent in the eluent channel 63 is, after being used subsequently, communicated with the regenerant solution channel 65 as a regenerant solution. K+ in the stock solution channel 64 enters the eluent channel 63 through the cation-exchange membrane 61; and OH⁻ generated from water electrolysis in the regenerant solution channel 65 enters the eluent channel 63 through the anion-exchange membrane 62.

The two-membrane eluent generator makes use of an eluent that has been used. But the eluent that has been used may include impurity ions from the tested sample. These impurity ions may return to the eluent through the ion-exchange membrane, which leads to low purity of the eluent and interfere with subsequent analytical experiments.

### SUMMARY

In order to ameliorate or solve at least one technical problem mentioned in the background, the present disclosure provides a two-membrane eluent generator and a chromatography detection apparatus.

A two-membrane eluent generator provided in an embodiment of the present disclosure includes a first eluent generator, the first eluent generator includes:
a stock solution channel, a stock solution in the stock solution channel supplying anions or cations for an eluent;
an eluent channel, water that has passed through the eluent channel forming the eluent, a first ion-exchange membrane set being arranged between the eluent channel and the stock solution channel, the first ion-exchange membrane set including at least one ion-exchange membrane, the ion-exchange membrane being a cation-exchange membrane or an anion-exchange membrane, cations or anions in the stock solution passing through the first ion-exchange membrane set to enter the eluent channel;
a regenerant solution channel, the eluent that has been used entering the regenerant solution channel to serve as a regenerant solution, a second ion-exchange membrane set being arranged between the eluent channel and the regenerant solution channel, the second ion-exchange membrane set including a bipolar membrane, hydrogen ions or hydroxide ions generated at the bipolar membrane from electrolysis of the regenerant solution allowed to enter different sides of the bipolar membrane respectively, the bipolar membrane being configured for preventing impurity ions that are not the hydrogen ions or the hydroxide ions from passing through the bipolar membrane and entering the eluent channel.

In at least one embodiment, the second ion-exchange membrane set further includes at least one cation-exchange membrane or anion-exchange membrane that is overlaid onto the bipolar membrane.

In at least one embodiment, either one of a positive electrode or a negative electrode is placed in the stock solution channel, one other of the positive electrode or the negative electrode is placed in the regenerant solution channel.

In at least one embodiment, the two-membrane eluent generator further includes a second eluent generator, wherein the second eluent generator includes an eluent channel,
the eluent channel of the first eluent generator and the eluent channel of the second eluent generator are in communication with each other such as to allow further adjustment to the eluent generated by the first eluent generator.

In at least one embodiment, the second eluent generator and the first eluent generator have the same structure,
the stock solution channel of the first eluent generator and a stock solution channel of the second eluent generator are not in communication with each other and are respectively supplied with a corresponding stock solution,
the regenerant solution channel of the first eluent generator and a regenerant solution channel of the second eluent generator are in communication with each other,
the eluent passes successively through the eluent channel of the first eluent generator and the eluent channel of the second eluent generator, and is then used and forms the regenerant solution, subsequently the regenerant solution passes successively through the regenerant solution channel of the second eluent generator and the regenerant solution channel of the first eluent generator and then forms a waste liquid and is discharged.

In at least one embodiment, regenerant solution channels are provided on both sides of the eluent channel of the second eluent generator, the eluent that has been used forms the regenerant solution, passes through the regenerant solution channels on both sides of the eluent channel of the second eluent generator and the regenerant solution channel of the first eluent generator, and then forms a waste liquid and is discharged.

In at least one embodiment, the second eluent generator is partitioned by two sets of the second ion-exchange membrane set into the eluent channel and the regenerant solution channels on both sides of the eluent channel.

The chromatography detection apparatus provided in an embodiment of the present disclosure includes the afore-described two-membrane eluent generator.

In at least one embodiment, the chromatography detection apparatus further includes a water source portion, a pump, a sample feeder, a chromatographic column, a suppressor, and a detector, wherein
under the action of the pump, water supplied by the water source portion enters the eluent channel and forms the eluent, the eluent passes through the sample feeder, the chromatographic column, the suppressor and the detector, and then enters the regenerant solution channel and forms the regenerant solution, and is then electrolyzed into a waste liquid and discharged from the regenerant solution channel.

In at least one embodiment, the chromatography detection apparatus further includes a stock solution bottle and a stock solution pump, wherein under the action of the stock solution pump, the stock solution circulates between the stock solution bottle and the stock solution channel, or
the stock solution bottle is directly connected to the stock solution channel.

The two-membrane eluent generator provided in the present disclosure applies a bipolar membrane between the regeneration channel and the eluent channel of the two-membrane eluent generator, thereby realizing corresponding H⁺ or OH⁻ supply for the eluent channel by electrolysis of the regenerant solution while preventing impurity ions in the regenerant solution from entering the eluent channel, and thus increasing the purity of the eluent.

The chromatography detection apparatus provided in the present disclosure includes the afore-described two-membrane eluent generator, and is therefore also endowed with the above advantages.

### BRIEF DESCRIPTION OF THE DRAWINGS

FIG. 1 is a schematic structural diagram of a chromatography detection apparatus including a two-membrane eluent generator.

FIG. 2 is a schematic diagram of the two-membrane eluent generator of FIG. 1.

FIG. 3, FIG. 4, FIG. 5, and FIG. 6 are schematic structural diagrams of four embodiments of the chromatography detection apparatus including the two-membrane eluent generator according to the embodiments of the present disclosure.

FIG. 7 and FIG. 8 are schematic diagrams of the two-membrane eluent generator according to an embodiment of the present disclosure.

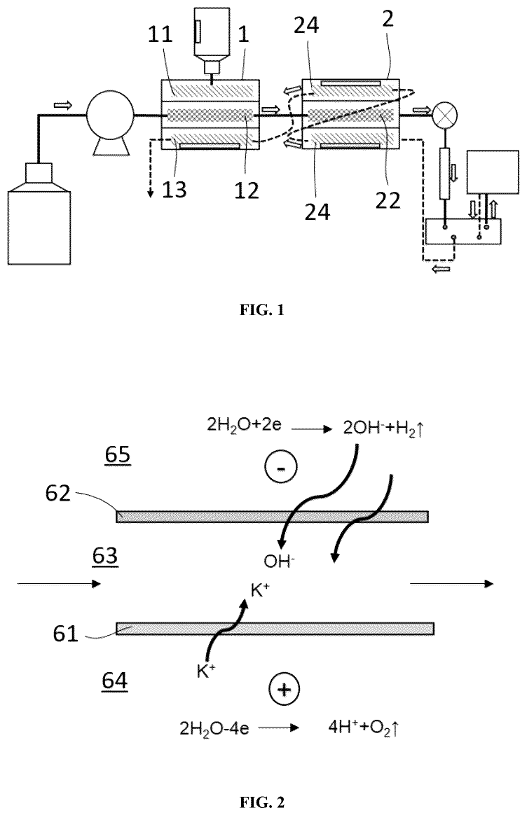

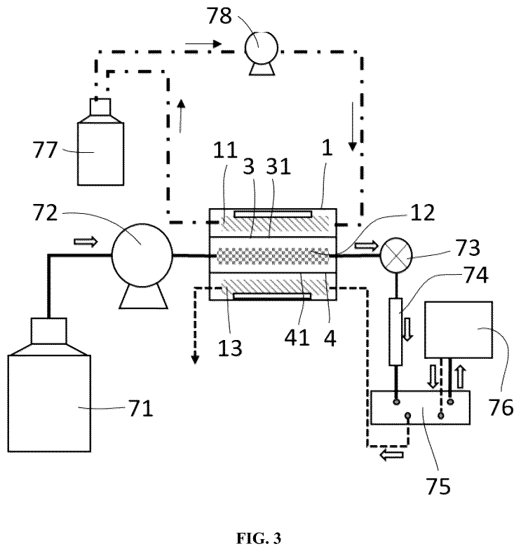

### LIST OF REFERENCE SIGNS

1 first eluent generator; 11 stock solution channel; 12 eluent channel; 13 regenerant solution channel;
2 second eluent generator; 21 stock solution channel; 22 eluent channel; 23 regenerant solution channel; 24 regenerant solution channel;
3 first ion-exchange membrane set; 31 ion-exchange membrane;
4 second ion-exchange membrane set; 41 bipolar membrane;
5 eluent generator;
61 cation-exchange membrane; 62 anion-exchange membrane; 63 eluent channel; 64 stock solution channel; 65 regenerant solution channel;
71 water source portion; 72 pump; 73 sample feeder; 74 chromatographic column; 75 suppressor; 76 detector; 77 stock solution bottle; 78 stock solution pump.

### DETAILED DESCRIPTION

Exemplary embodiments of the present disclosure are described below with reference to the drawings. It is understood that these specific descriptions are merely an inspiration for those skilled in the art to implement the present disclosure. It is not intended to enumerate the implementations of the present disclosure in an exhaustive manner or to limit the present disclosure.

A bipolar membrane is an ion-exchange membrane of a special ionic structure compounded by an anodic membrane and a cathodic membrane, which both anions and cations cannot penetrate. However, under the action of a direct-current electric field, H₂O between the composite layers of the anodic membrane and the cathodic membrane in the bipolar membrane is dissociated into H+ and OH− that are allowed to pass through the anodic membrane and the cathodic membrane respectively to enter corresponding sides of the bipolar membrane. Therefore, by applying a bipolar membrane between the regeneration channel and the eluent channel of the two-membrane eluent generator, it is possible to realize corresponding H⁺ or OH⁻ supply for the eluent channel by electrolysis of the regenerant solution while preventing impurity ions in the regenerant solution from entering the eluent channel.

The present disclosure provides a two-membrane eluent generator and a chromatography detection apparatus that embodies the above idea.

Subsequently several embodiments of the present disclosure are described.

### Embodiment 1

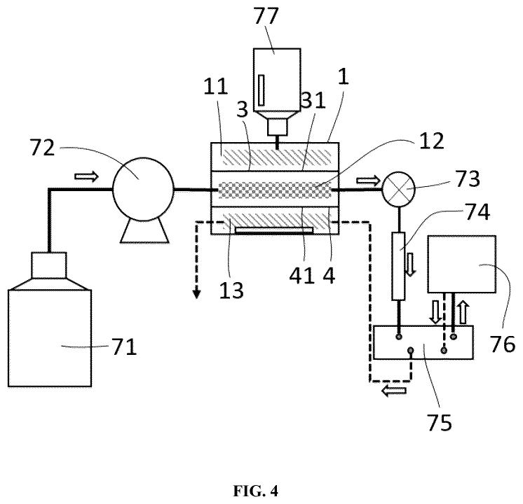

With reference to FIG. 3, Embodiment 1 provides a two-membrane eluent generator, including a first eluent generator 1. The first eluent generator 1 includes a stock solution channel 11, an eluent channel 12, and a regenerant solution channel 13.

The stock solution in the stock solution channel 11 supplies the required anions or cations, e.g., potassium ions, etc., of high concentration for the eluent.

Water (e.g., pure water) in the eluent channel 12 passes through the eluent channel 12 to form the eluent. A first ion-exchange membrane set 3 is provided between the eluent channel 12 and the stock solution channel 11. The first ion-exchange membrane set 3 includes at least one ion-exchange membrane 31. The ion-exchange membrane 31 is a cation-exchange membrane or an anion-exchange membrane. Cations or anions in the stock solution pass through the first ion-exchange membrane set 3 to enter the eluent channel 12.

The eluent that has been used enters the regenerant solution channel 13 to form the regenerant solution. A second ion-exchange membrane set 4 is provided between the eluent channel 12 and the regenerant solution channel 13. The second ion-exchange membrane set 4 includes a bipolar membrane 41. Hydrogen ions or hydroxide ions generated at the bipolar membrane 41 from electrolysis of the regenerant solution are allowed to enter different sides of the bipolar membrane 41 respectively. The bipolar membrane 41 is configured for preventing impurity ions that are not hydrogen ions or hydroxide ions from passing through the bipolar membrane 41 and entering the eluent channel 12. It can be understood that the eluent that has been used may refer to the eluent that has gone through subsequent test operations performed by a sample feeder, a chromatographic column, a detector, and the like.

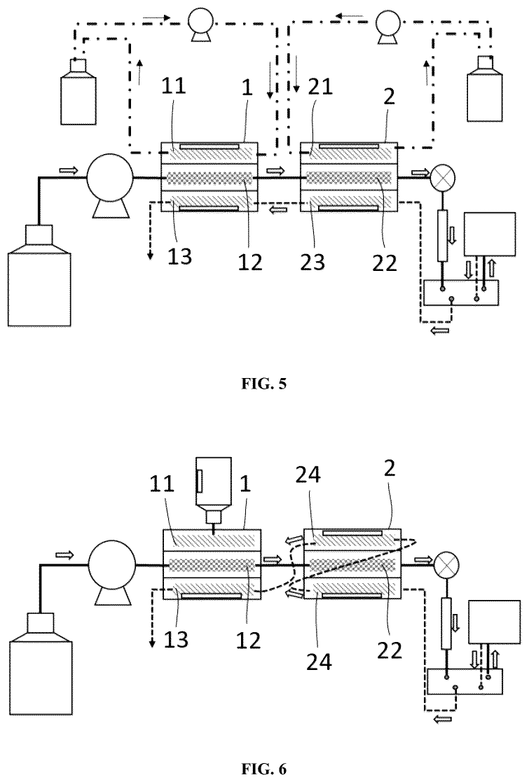

Illustratively, referring to FIG. 7, when the eluent is required to be KOH for example, the ion-exchange membrane 31 can be the cation-exchange membrane. K⁺ in the stock solution channel 11 is allowed to pass through the cation-exchange membrane to enter the eluent channel 12. The membrane of the bipolar membrane 41 facing towards the eluent channel 12 is the cathodic membrane. OH⁻ produced from water by electrolysis in the bipolar membrane 41 is allowed to pass through the cathodic membrane to enter the eluent channel 12. Meanwhile, impurity ions are prevented from entering the eluent channel 12, so the eluent is of higher purity and contains fewer impurities.

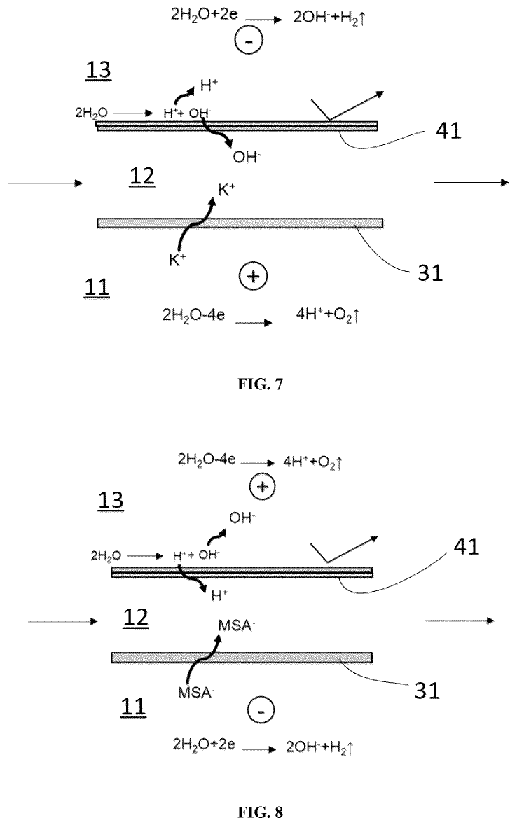

Illustratively, referring to FIG. 8, when the eluent is required to be MSA (methylsulfonate, chemical formula CH₄O₃S) for example, the ion-exchange membrane 31 can be the anion-exchange membrane. Anions of MSA in the stock solution channel 11 (see FIG. 8, anions of MSA is represented by MSA⁻) are allowed to pass through the anion-exchange membrane to enter the eluent channel 12. The membrane of the bipolar membrane 41 facing towards the eluent channel 12 is the anodic membrane. H⁺ produced from water by electrolysis in the bipolar membrane 41 is allowed to pass through the anodic membrane to enter the eluent channel 12. Meanwhile, impurity ions are prevented from entering the eluent channel 12, so the eluent is of higher purity.

It can be understood that the afore-described application of the ion-exchange membrane and the eluent is merely an example. The present disclosure does not limit the specific type of the eluent or the ion-exchange membrane.

Further, referring to FIG. 7 and FIG. 8, the second ion-exchange membrane set 4 may include at least one cation-exchange membrane or anion-exchange membrane overlaid onto the bipolar membrane 41. The first ion-exchange membrane set 3 may alternatively be constructed by a plurality of ion-exchange membranes 31 overlaid together. It can be understood that the structure of multiple layers of membranes overlaid is conducive to increased mechanical strength of the membrane and increased durability.

Further, referring to FIG. 3, either one of a positive electrode or a negative electrode is placed in the stock solution channel 11 and the other of the positive electrode and the negative electrode in the regenerant solution channel 13. The positive electrode and the negative electrode may be respectively connected with a constant-current power supply. It can be understood that the present disclosure does not limit the specific locations of the positive electrode and the negative electrode; and the electrode may be reasonably positioned in accordance with the type of the stock solution and the position of each channel. It is possible to control the electrolysis of water and the amount of migrant ions by controlling the current value set for the constant-current power supply, thereby controlling the concentration of the eluent.

Referring to FIG. 3, the chromatography detection apparatus provided in the present disclosure may include the afore-described two-membrane eluent generator as well as a water source portion 71, a pump 72, a sample feeder 73, a chromatographic column 74, a suppressor 75, a detector 76, a stock solution bottle 77, and a stock solution pump 78.

Driven by the pump 72, water (e.g., pure water) supplied by the water source portion 71 enters the eluent channel 12 to form the eluent. The eluent passes through the sample feeder 73, the chromatographic column 74, the suppressor 75, and the detector 76 and enters the regenerant solution channel 13 to form the regenerant solution. The regenerant solution is discharged after being electrolyzed and utilized.

Driven by the stock solution pump 78, the stock solution may circulate in the stock solution bottle 77 and the stock solution channel 11. The circulation causes air bubbles to flow, thereby avoiding aggregation of bubbles which may affect the electrolysis process. As compared to a solution of providing stock solution channels on both sides of the eluent channel, the stock solution channel in the present disclosure is shorter so that the stock solution pump 78 needs only to exhaust bubbles from the channel on one side. As a result, the rotation speed of the stock solution pump 78 can be lower, with the produced noise reduced. Illustratively, the stock solution pump 78 may be a peristaltic pump.

### Embodiment 2

As compared to Embodiment 1 shown in FIG. 3, the two-membrane eluent generator per se is not changed in Embodiment 2 as shown in FIG. 4. The improvement of Embodiment 2 lies in the connection between the stock solution bottle and the stock solution channel. Specifically the stock solution bottle 77 is directly connectable to the stock solution channel 11, without occurrence of circulation within the channel, so that bubbles in the stock solution channel 11 may directly enter the interior of the stock solution bottle 77 or may be discharged via the stock solution bottle 77, thereby reducing the number of pumps.

### Embodiments 3 and 4

Referring to FIG. 5 and FIG. 6, the two-membrane eluent generator may further include a second eluent generator 2. The second eluent generator 2 includes an eluent channel 22. The eluent channel 12 of the first eluent generator 1 and the eluent channel 22 of second eluent generator 2 are in communication with each other such as to allow further adjustment to the eluent produced by the first eluent generator 1.

In Embodiment 3, referring to FIG. 5, the second eluent generator 2 and the first eluent generator 1 have the same structure.

The stock solution channel 11 of the first eluent generator 1 and the stock solution channel 21 of the second eluent generator 2 are not in communication with each other and are respectively supplied with corresponding stock solutions. The stock solutions may be of the same type.

The regenerant solution channel 13 of the first eluent generator 1 and the regenerant solution channel 23 of the second eluent generator 2 are in communication with each other. The eluent passes successively through the eluent channel 12 of the first eluent generator 1 and the eluent channel 22 of the second eluent generator 2, and is then used and forms the regenerant solution. Subsequently the regenerant solution passes successively through the regenerant solution channel 23 of the second eluent generator 2 and the regenerant solution channel 13 of the first eluent generator 1, and then forms a waste liquid and is discharged.

In Embodiment 4, referring to FIG. 6, the regenerant solution channels 24 are provided on both sides of the eluent channel 22 of the second eluent generator 2. The eluent that has been used forms the regenerant solution, passes through the regenerant solution channels 24 on both sides of the eluent channel 22 of the second eluent generator 2 and the regenerant solution channel 13 of the first eluent generator 1, forms a waste liquid, and is discharged.

The second eluent generator 2 may be portioned into the eluent channel 22 and the two regenerant solution channels 24 on both sides of the eluent channel 22 by two sets of the second ion-exchange membrane set 4.

In Embodiments 3 and 4, the second eluent generator 2 actually performs a secondary adjustment on the eluent. By controlling the type and the concentration (Embodiment 3) of the stock solution, it is possible to control a degree of water electrolysis by the electrodes, thereby adjusting the parameters such as alkalinity acidity and concentration of the eluent.

Certainly the usage is extendable by connecting more eluent generators, changing the eluent channel between eluent generators, or changing the connection with the regenerant solution channel.

The chromatography detection apparatus provided in the present disclosure may be a liquid chromatography detection apparatus, an ion chromatography detection apparatus, etc.

Described in the foregoing are preferable embodiments of the present disclosure. Note that those skilled in the art can make several improvements and modifications without departing from the principles of the present disclosure, and such improvements and modifications should be considered encompassed in the scope of the present disclosure.

1. A two-membrane eluent generator, comprising a first eluent generator, wherein the first eluent generator comprises:
a stock solution channel, a stock solution in the stock solution channel supplying anions or cations for an eluent;
an eluent channel, water that has passed through the eluent channel forming the eluent, a first ion-exchange membrane set being arranged between the eluent channel and the stock solution channel, the first ion-exchange membrane set comprising at least one ion-exchange membrane, the ion-exchange membrane being a cation-exchange membrane or an anion-exchange membrane, cations or anions in the stock solution passing through the first ion-exchange membrane set to enter the eluent channel;
a regenerant solution channel, the eluent that has been used entering the regenerant solution channel to serve as a regenerant solution, a second ion-exchange membrane set being arranged between the eluent channel and the regenerant solution channel, the second ion-exchange membrane set comprising a bipolar membrane, hydrogen ions or hydroxide ions generated at the bipolar membrane from electrolysis of the regenerant solution allowed to enter different sides of the bipolar membrane respectively, the bipolar membrane being configured for preventing impurity ions that are not the hydrogen ions or the hydroxide ions from passing through the bipolar membrane and entering the eluent channel.

2. The two-membrane eluent generator according to claim 1, wherein the second ion-exchange membrane set further comprises at least one cation-exchange membrane or anion-exchange membrane that is overlaid onto the bipolar membrane.

3. The two-membrane eluent generator according to claim 1, wherein either one of a positive electrode or a negative electrode is placed in the stock solution channel, one other of the positive electrode or the negative electrode is placed in the regenerant solution channel.

4. The two-membrane eluent generator according to claim 1, further comprising a second eluent generator, wherein the second eluent generator comprises an eluent channel,
the eluent channel of the first eluent generator and the eluent channel of the second eluent generator are in communication with each other such as to allow further adjustment to the eluent generated by the first eluent generator.

5. The two-membrane eluent generator according to claim 4, wherein the second eluent generator and the first eluent generator have the same structure,
the stock solution channel of the first eluent generator and a stock solution channel of the second eluent generator are not in communication with each other and are respectively supplied with a corresponding stock solution,
the regenerant solution channel of the first eluent generator and a regenerant solution channel of the second eluent generator are in communication with each other,
the eluent passes successively through the eluent channel of the first eluent generator and the eluent channel of the second eluent generator, and is then used and forms the regenerant solution, subsequently the regenerant solution passes successively through the regenerant solution channel of the second eluent generator and the regenerant solution channel of the first eluent generator and then forms a waste liquid and is discharged.

6. The two-membrane eluent generator according to claim 4, wherein regenerant solution channels are provided on both sides of the eluent channel of the second eluent generator, the eluent that has been used forms the regenerant solution, passes through the regenerant solution channels on both sides of the eluent channel of the second eluent generator and the regenerant solution channel of the first eluent generator, and then forms a waste liquid and is discharged.

7. The two-membrane eluent generator according to claim 6, wherein the second eluent generator is partitioned by two sets of the second ion-exchange membrane set into the eluent channel and the regenerant solution channels on both sides of the eluent channel.

8. A chromatography detection apparatus, comprising the two-membrane eluent generator according to claim 1.

9. The chromatography detection apparatus according to claim 8, further comprising a water source portion, a pump, a sample feeder, a chromatographic column, a suppressor, and a detector, wherein
under an action of the pump, water supplied by the water source portion enters the eluent channel and forms the eluent, the eluent passes through the sample feeder, the chromatographic column, the suppressor and the detector, and then enters the regenerant solution channel and forms the regenerant solution, and is then electrolyzed into a waste liquid and discharged from the regenerant solution channel.

10. The chromatography detection apparatus according to claim 8, further comprising a stock solution bottle and a stock solution pump, wherein under an action of the stock solution pump, the stock solution circulates between the stock solution bottle and the stock solution channel, or
the stock solution bottle is directly connected to the stock solution channel.
